(19) United States
(12) Patent Application Publication
(10) Pub. No.: US 2017/0059606 A1
(43) Pub. Date: Mar. 2, 2017

(54) OPTICAL ACCELEROMETER

(71) Applicant: Sercalo Microtechnology Ltd., Schaan (LI)

(72) Inventors: Peter Herbst, Schaan (LI); Cornel Marxer, Schaan (LI)

(21) Appl. No.: 15/246,759

(22) Filed: Aug. 25, 2016

(30) Foreign Application Priority Data
Aug. 25, 2015 (CH) 01222/15

(51) Int. Cl. G01P 15/093; G01N 21/47; G01P 1/02

(52) U.S. Cl. CPC G01P 15/093; G01P 1/023; G01N 21/474; G01N 2021/4742

(57) ABSTRACT

The invention relates to an optical accelerometer, comprising a seismic mass, equipped with a mobile reflective surface, according to a rotating axis, an emitting optical fiber, coupled with a light source, intended to emit a light beam, through one of its edges, in the direction of the reflective surface, and a receiving optical fiber, coupled with an optical detector, intended to receive, through one of its edges-, the light beam sent back by the reflective surface. The arrangement of the ensemble is such that a rotating movement of the reflective surface leads to a deflection of the light beam and a variation in the light intensity received by the receiving fiber. According to the invention, a convergent lens is interposed, on the optical path of the light beam, between the optical fibers and the seismic mass.

### CROSS REFERENCE TO RELATED APPLICATIONS

This application claims priority to Swiss Patent Application No. 01222/15 filed Aug. 25, 2015, the entirety of which is incorporated by this reference.

This invention relates to the domain of accelerometers. It relates, more specifically, to an optical accelerometer, coupling a seismic mass to at least one optical fiber.

Such accelerometers are known as the experts, and function according to a simple generic principle: A seismic mass cooperates with an optical fiber, emitting a light beam. Under the effect of acceleration, the seismic mass moves, causing a deflection in the light beam, which gives an indication of the acceleration. They are intended for the surveillance of installations subject to hostile environments, such as electric generators, wind turbines, trains, or any other critical construction.

Different devices, based on his principle, are described in the technical overview. Document US2007/0247613, for example, reveals an accelerometer comprising an emitting optical fiber and a receiving optical fiber, optically aligned in relation to a partially reflective and partially absorbent target. A seismic mass, connected to the optical fibers, moves under the effect of acceleration, leading to the misalignment of optical fibers in relation to their initial position, and a variation in light intensity received by the receiving fiber. The patent, U.S. Pat. No. 8,770,024 describes an accelerometer including an emitting optical fiber and a receiving optical fiber facing each other. The seismic mass is constituted by the emitting fiber itself, which oscillates under the effect of acceleration.

Document U.S. Pat. No. 5,437,186, finally, presents an accelerometer comprised of an emitting optical fiber, a receiving optical fiber and a seismic mass formed of a rotating mobile plane element. The said seismic mass is classically constituted of a micromechanical element, or MEMS (MicroElectroMechanical System), which includes a solid frame and a sold, flat plate which is connected to it by bending beams. The edge of the emitting fiber is positioned, joined to the flat plate, opposite and in immediate proximity to the edge of the receiving fiber, positioned on the frame. In a neutral position, in other words, in the absence of acceleration, the optical fibers are aligned and the light intensity received by the receiving fiber is at a maximum. In the presence of acceleration, perpendicular to the seismic mass plane, the flat plan rotates, leading to the emitting fiber. The emitted light beam is deflected and the spot formed by the impact of the light beam entering the receiving fiber moves laterally. The variation in light intensity received gives an indication of acceleration.

Such a device, although functional and a simple design, presents several disadvantages. Firstly, the contact between the optical fibers and the MEMS is problematic: Its implementation, through bonding or welding, is difficult, and the rotating movement of the mobile plate is disturbed, which has a direct impact on the accuracy of the measurement. Moreover, the positioning of the emitting and receiving fibers facing each other is not optimal. Indeed, such a device is generally shut away in an airtight box, to protect it from the outside environment. The optical fibers thus aligned emerge from the box through two separate and opposite faces, which gives the device a significant bulk, and complicates the integration of the accelerometer to the measuring point. In addition, the airtightness of the box is compromised by the fibers which cross it. Finally, the displacement of the spot produced by the impact of the light beam entering the receiving fiber depends on the deflection of the light beam, that is from the rotation, a, of the flat plate. More specifically, the displacement of the spot is proportional to the tangent of the angle, a, about equal to a for angles less than or equal to 15°, and to the width of the seismic mass. Given the dimensions of the MEMS, the effect of low acceleration only produces a minimal displacement of the light beam, and, consequently, a very low variation in the light intensity received. The sensitivity of the accelerometer thus described is then mediocre.

The present invention remedies the disadvantages outlined above, by proposing an accelerometer presenting great measuring sensitivity, coupled with increased accuracy. In addition, the structure of the accelerometer, according to the invention, enables facilitated integration of the device to the point where the measurement must be made, using the position of the fibers exiting the box. More specifically, the invention relates to an optical accelerometer comprising a seismic mass, equipped with a mobile reflective surface, according to a rotating axis, an emitting optical fiber coupled with a light source, intended to emit a light beam, through one of its edges, in the direction of the reflective surface, and a receiving optical fiber, coupled with an optical detector, intended to receive, through one of its edges, the light beam sent by the reflecting surface, a rotating movement of the reflective surface, leading to a deflection of the light beam and a variation in the light intensity received by the receiving fiber. According to the invention, a convergent lens is interposed, on the optical path of the light beam, between the optical fibers of the said seismic mass.

The presence of a convergent lens, interposed between the emitting and receiving fibers of the accelerometer, according to the invention, gives a physical distance between the fibers and the seismic mass. The effects produced remove the problematic contact between the fibers and the seismic mass, and increase the optical path of the light beam between the emitting and receiving fibers. In terms of the accelerometer's performance, these effects are conveyed by an improvement in the accuracy of the measurement and an increased sensitivity. For an angle of deflection, a, of the given seismic mass, the geometry of the device according to the invention enables a substantial displacement of the light beam upon entering the receiving fiber, and, consequently, an increased sensitivity to low acceleration, as it will subsequently appear. Another consequence of the optical fibers being distant from the seismic mass, is the facilitated encapsulation of the seismic mass in an airtight box. The optical fibers, being distant from the seismic mass, it is possible to move them outside of the airtight box, the lens being positioned directly on it. This structure has its advantages, as it is difficult to position optical fibers in an airtight way through a separation between two environments. Finally, it is noted, that within the accelerometer, according to the invention, the function of the seismic mass is to reflect the light beam emitted in a direction which varies in accordance with the subjected acceleration. This characteristic makes use of different positions relating to the longitudinal axes of the optical fibers. In particular, the emitting and receiving fibers can be parallel and next to one another, in which case, they emerge from the device through one same face, and the bulk of the device is minimal.

Other characteristics and advantages of this invention will appear whilst reading the description which follows, given only as an example, and referenced in the appended drawings, wherein:

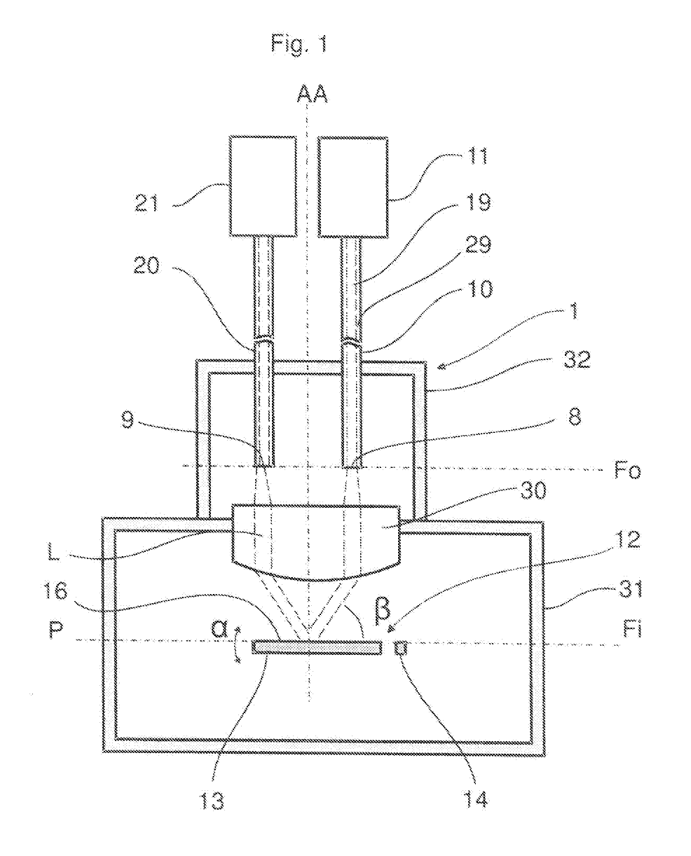

FIGS. 1 to 3 are side diagrams of different methods of producing an optical accelerometer, according to the invention,

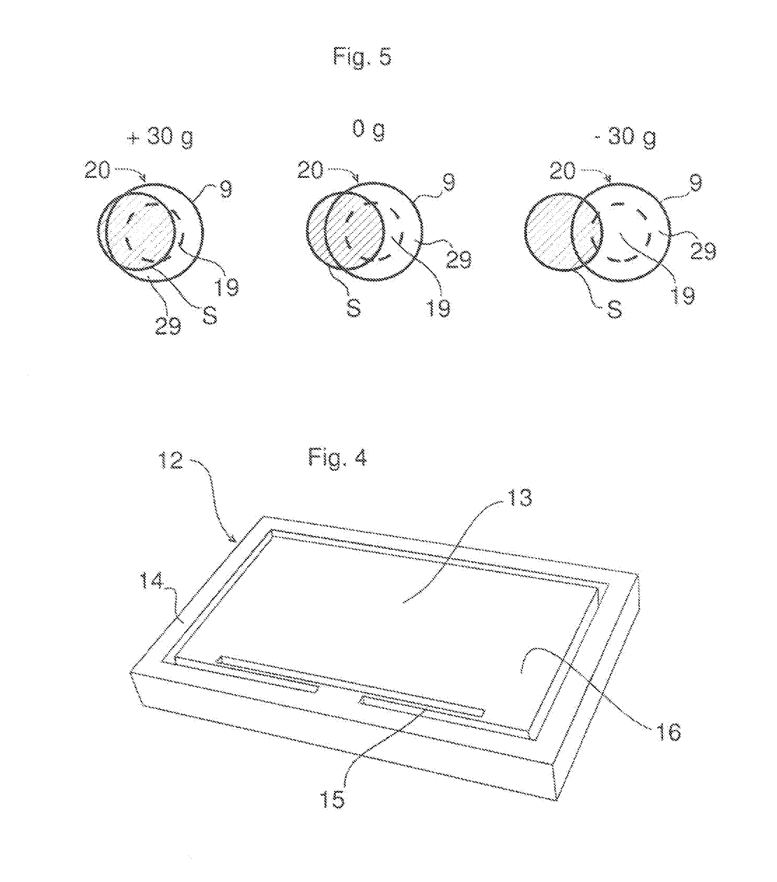

FIG. 4 is a perspective view of a seismic mass belonging to the accelerometer, according to the invention, and

FIG. 5 illustrates, as a diagram, the principle of determining acceleration using the accelerometer, according to the invention.

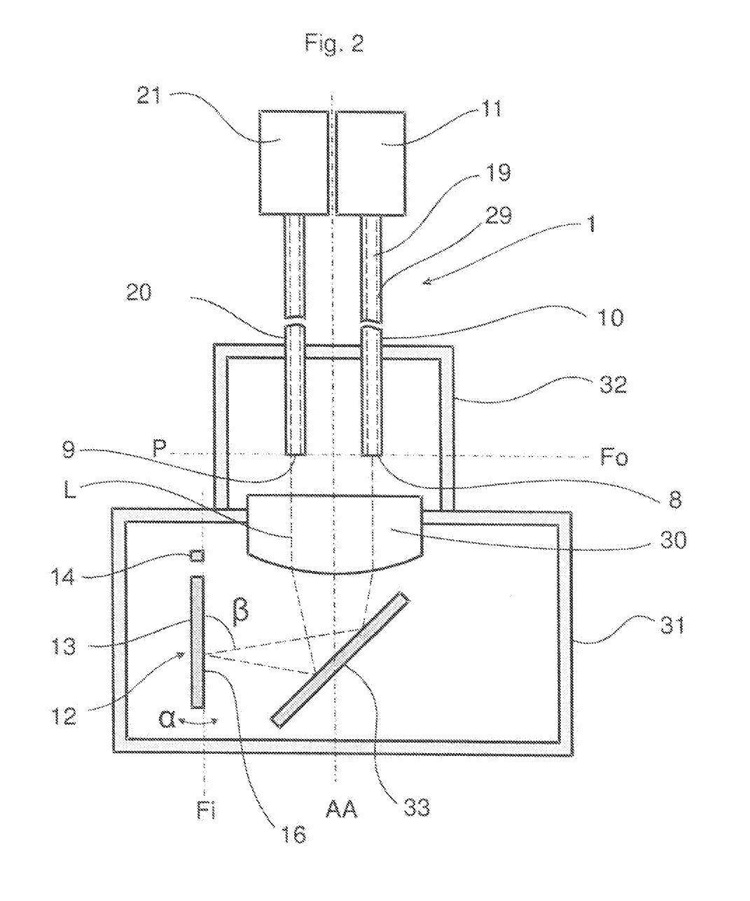

The optical accelerometer, represented through diagrams in FIGS. 1 and 2, and referenced as a whole 1, includes, classically, an emitting optical fiber 10, coupled with a light source 11, formed, for example, with an LED (light-emitting diode), a laser diode, or other. The emitting fiber 10 is intended to deliver, through one of its edges 8, a light beam L, in the direction of a seismic mass 12, able to become distorted flexibly under the effect of acceleration.

To this end, the seismic mass 12, illustrated in FIG. 4, is formed by a solid inertia plate 13, positioned connected, rotating around a solid frame 14, using recall beams 15, flexible and twisting. As a variant, the recall beams 15 can be distorted while bending. The inertia plate 13 is equipped with a reflective surface 16, such as a mirror, a metallic film, or other, of which the function is to send back the light beam L. In a neutral position, in other words, in the absence of acceleration, the seismic mass 12 is flat and the inertia plate 13 / frame 14 ensemble, defines a plane P. Under the effect of acceleration comprising a component, perpendicular to the plane P, the plate 13, rotates by the effect of inertia, forming an angle, a, with the plane P. The seismic mass 12 is, advantageously, constituted of a micromechanical element, or MEMS (MicroElectroMechanical System), which is produced by micromachining techniques, well known to the expert.

The sensor 1 again includes a receiving optical fiber 20, coupled with an optical detector 21, either photodiode or phototransistor. It is intended to collect, through one of its edges 9, the light beam L emitted by the emitting fiber 10, and reflected by the inertia plate 13. The emitting fiber 10 and receiving fiber 20 are classically formed by a core 19, surrounded by a sheath 29.

According to the invention, a convergent lens 30, of the optical axis AA, of a focal distance F, of an object focal plane Fo and of an image focal plane Fi, is interposed on the optical path of the light beam L, halfway between the optical fibers 10, 20, and the seismic mass 12. The edges 8, 9, respective of the emitting and receiving fibers 10, 20, are located in the first object focal plane Fo of the lens 30, while the plane P defined by the seismic mass 12 is at focal distance F of the lens 30.

In the fulfilment method illustrated in FIG. 1, the plane P defined by the seismic mass coincides with the object focal plane Fo and the emitting fiber 10 and receiving fiber 20 are parallel to the axis AA and essentially symmetrical in relation to the axis AA. This arrangement is particularly compact and enables a simple alignment of different optical elements. Advantageously, and such as illustrated in FIG. 5, the emitting fiber 10 and receiving fiber 20 are slightly shifted laterally in relation to the symmetry of the axis AA. This initial shift is approximately the size of the core radius 19 of the receiving fiber 20, and enables the direction of the vibration to be determined, as it will consequently appear.

A first box 31, that may be airtight, contains the seismic mass 12 in a way to protect the surrounding atmosphere, the dust or the interference radiation. The lens 30 is positioned airtight on the box 31, for example, using a seal. As a variant, the first box 31 is not airtight, but hermetic or simply closed in a way which offers mechanical and optical protection. The emitting optical fiber 10 and receiving fiber 20 are located on the outside of the box 31, their edges 8, 9 being at a focal distance from the lens 30, in a way to, respectively, inject and receive the light beam L. A second box 32, positioned side-by-side with the first box 31, forms a compartment, closed around the lens 30 and the terminal section of the optical fibers 10, 20. The interface between the second box 32 and the emitting fiber 10 and receiving fiber 20, which emerge from it, is made using a seal, or a solid component, ensuring the said fibers are held, and a mechanical and optical obstruction.

The functioning of the accelerometer 1, according to the invention, is as follows: In the absence of acceleration, the reflective surface 16 is perpendicular to the axis AA. The light beam L, emitted by the emitting fiber 10, crosses the convergent lens 30, of which it appears collimated and deviated in relation to the direction AA. It hits the reflective surface 16 under an angle of incidence 13, and is reflected under this same angle in the direction of the lens 30, of which it appears parallel to the axis AA. It is then collected by the receiving fiber 20, which transmits an optical signal to the detector 21. Because of the initial lateral shift of the fibers 10, 20, the light beam L impacting the receiving fiber 20 in a neutral position, is shifted laterally in relation to the core 19 of the fiber 20 in a way to only transmit 50 percent of the intensity emitted. This initial shift of the impact spot S on the edge 9 of the receiving fiber 20 is illustrated in FIG. 5. When the sensor 1 is subjected to an acceleration comprising a component, perpendicular to the plane P, the inertia plate 13 is inclined from an angle a, in relation to the plane P, and the light beam L is reflected by the reflective surface 16 under an angle equal to β±2α. By a geometric effect, this angular variation leads to a lateral shift d of the spot S in relation to the edge 9 of the fiber 20, which is added to or subtracted from the initial shift, according to the direction of acceleration subjected to. This effect, represented, for information purposes in FIG. 5, enables an indication of the intensity of acceleration supported to be given, as well as its direction. For example, the light intensity measured by the detector 21 is maximal for a positive acceleration of 30 g; It is nothing for a negative acceleration of 30 g, g being land acceleration, which is around 9.81 m/s².

These values are for information purposes only, as the sensitivity of the accelerometer 1 depends on the lens 30 used, and the sensitivity of the seismic mass 12 itself. But, as a comparison with the accelerometer revealed in the document, U.S. Pat. No. 5,437,186, it is revealed that the lateral shift of the spot S entering the receiving fiber 20 is proportional to the tangent 2a multiplied by the focal distance for the accelerometer 1, according to the invention, while it is proportional to the tangent α, multiplied by the distance between the fibers for the technical overview. From this, it appears that, for one same seismic mass 12 and for a low angle of deflection α, the sensitivity of the accelerometer 1, according to the invention, is increased by a factor of at least two. In practice, this increase can reach a factor 10. Moreover, it is difficult to assess the improvement in accuracy of the measurement, but the absence of contract between the fibers 10, 20 and the seismic mass 12, contributes to eliminating the errors generated by the assembly of these components.

Now, FIG. 2 is referred to, representing a variant in the method of producing the accelerometer 1, according to the invention. This method of production differs from the previous one, in that the axis AA of the lens 30 is parallel to the plane P of the seismic mass 12, and in that a provisional mirror 33, making an angle of 45° with the axis AA and the plane P, is interposed between the lens 30 and the seismic mass 12 in a way to direct the light beam L towards the reflective surface 16. This arrangement modifies nothing regarding the functioning of the accelerometer described previously, but enables an acceleration in a direction, perpendicular to the axis AA of the lens 30 to be measured, without modifying the direction of the sensor 1. It is thus practical to have several sensors, according to the invention, side by side, in a very compact way, for the purpose of measuring the acceleration according to several chosen directions.

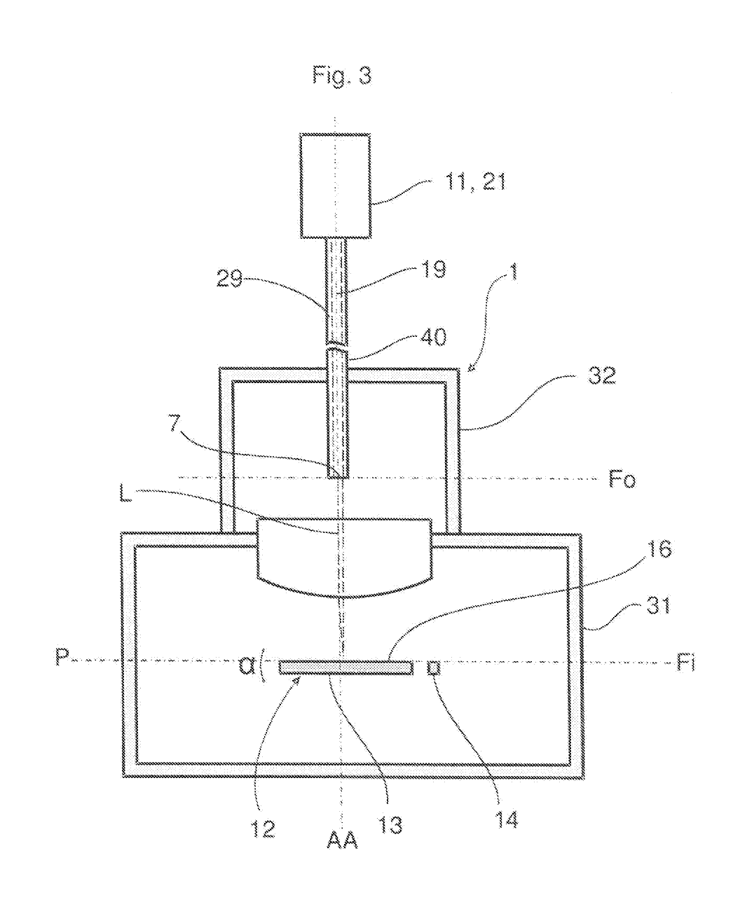

FIG. 3, finally, illustrates a variant in the method of producing the accelerometer 1, according to the invention, wherein the respectively emitting fiber 10 and receiving fiber 20, are combined into one single fiber 40. This is aligned on the axis AA of the lens 30, and it is slightly offset. Its edge 7 is located in its object focal plane Fo. The light source 11 and the optical detector 21 are then combined by an optical coupler. This method of production presents the advantage of its great simplicity, particularly concerning the optical alignment, and consequently, its manufacturing costs are reduced. The principle of its functioning is unchanged.

Therefore, an optical accelerometer has been described, efficient and easy to integrate, because of its innovative structure, in particular because of using a convergent lens. Of course, this invention is not limited to the methods of production described above, but is extended to all variants within the reach of the expert, falling into the framework of the claims below.

1-12. (canceled)

13. An optical accelerometer, comprising:
a seismic mass equipped with a mobile reflective surface according to a rotating axis;
an emitting optical fiber coupled to a light source and configured to emit a light beam through one of its edges in the direction of the mobile reflective surface;
a receiving optical fibre coupled with an optical detector configured to receive through one of its edges the light beam sent back by the reflective surface; and
a convergent lens interposed on an optical path of the light beam between the emitting and receiving optical fibres and the said seismic mass;
wherein a rotating movement of the reflective surface causes a deflection of the light beam and a variation in the light intensity received by the receiving fiber.

14. The accelerometer according to claim 13, wherein the lens is an optical axis AA of focal distance F of object focal plane Fo and in that the edges respectively of emitting fiber and receiving fiber are located in the object focal plane Fo.

15. The accelerometer according to claim 13, wherein the lens is of image focal plane Fi and the seismic mass is flat and defines a plane P coinciding with the image focal plane Fi.

16. The accelerometer of claim 14, wherein the lens is of image focal plane Fi and the seismic mass is flat and defines a plane P perpendicular to the object focal plane Fo, and further comprising a mirror positioned at 45° in relation to the axis AA and interposed between the lens and the seismic mass, in a way to direct the light beam towards the reflective surface.

17. The accelerometer according to claim 14, wherein the optical fibers are parallel to the axis AA and essentially symmetrical in relation to the said axis AA.

18. The accelerometer according to any claim 13, wherein the emitting fiber and the receiving fiber are separate.

19. The accelerometer according to claim 13, wherein the emitting fiber and the receiving fiber are combined.

20. The accelerometer according to claim 13, wherein an alignment of the optical fibres, of the lens and the seismic mass is such that the light beam is shifted from around half of its section entering the receiving optical fibre when there is no acceleration.

21. The accelerometer according to claim 13, wherein the seismic mass is formed from an inertia plate equipped with the reflective surface positioned connected rotating on a solid frame by provisional recall beams flexible and twisting.

22. The accelerometer according to claim 13, further comprising a first box wherein the said seismic mass is positioned and whereon the convergent lens is positioned.

23. The accelerometer according to claim 22, further a second box positioned side-by-side with the first box and wherein the said edges of the emitting fiber and receiving fiber are positioned.
